(19) United States
(12) Patent Application Publication
(10) Pub. No.: US 2004/0049460 A1
(43) Pub. Date: Mar. 11, 2004

(54) Method and device for providing secure of an electronic authorization/credit card

(76) Inventors: Av Doron, Timrat (IL); Shlomo Shaine, Migdal Haemek (IL)

Correspondence Address: SUGHRUE MION, PLLC, 2100 PENNSYLVANIA AVENUE, N.W., WASHINGTON, DC, 20037, US

(21) Appl. No.: 10/363,779

(22) PCT Filed: Sep. 7, 2001
(86) PCT No.: PCT/IB01/02569

(30) Foreign Application Priority Data
Sep. 7, 2000 (IL) 138323

(51) Int. Cl. G06F 17/60

(52) U.S. Cl. 705/41

(57) ABSTRACT

A smart electronic authorization/credit card called a Smart Key Card (SKC) and a method for its operation are provided. The SKC includes a keypad for entering data, a magnetic strip or a Smart Card Chip which stores confidential information, a battery, NVM memory that stores program code and data, a CPU and a Smart Key Card hybrid chip. The SKC is activated by the authorized user for a predetermined time period. The method for operating the SKC includes entering a secret code through the keypad on the SKC, comparing the entered secret code to a true code stored in the SKC, and activating the SKC for a predetermined time period, when the entered secret code and the true code are the same. The data stored in the SKC can be modified by a user using the keypad and a display on the SKC.

### BACKGROUND OF THE INVENTION

1. Field of the Invention

The present invention relates to an electronic authorization/credit card and methods for its operation, and more specifically to a smart electronic authorization/credit card, which is protected against theft by being enabled only when activated by a user entering a secret code on the card and operation methods therefor. The present application is based on Israeli Patent Application No. 138323, which is incorporated herein by reference.

2. Description of the Related Art

Conventional credit cards suffer from the drawback that when obtained by someone other than the owner of the card, whether by theft or otherwise, the cards can be used without authorization from the owner. Thus, fraudulent use of credit cards occurs rather easily.

Conventional credit cards are always in a state of activation, since the magnetic strip or Smart card chip is always activated. Thus, when using a conventional credit card, an unauthorized user simply needs to have the card number, which is printed on the card itself, when making Internet, telephone transactions, or other remote transactions. When making a typical transaction in person, the unauthorized user simply has to have the card and sign a receipt with the forged signature of the name of the owner of the card. Therefore, it is difficult to prevent the fraudulent use of a conventional credit card.

### SUMMARY OF THE INVENTION

In an illustrative, non-limiting embodiment of the invention, a Smart Key Card (SKC) is provided, which is a computer that could be packaged as a conventional credit card according to the international and commercial standards of credit cards. It packages all the main components of a computer: CPU, memory, input and output accessories.

The SKC comes in either a magnetic strip type or a smart card chip type. The magnetic strip type adheres to the familiar credit card standards that have been on the market for many years. The smart card chip type adheres to the smart card standards that are new to the market.

The SKC can be carried in the same manner one carries a conventional credit card. The SKC has the look and feel of a credit card. The SKC has all the basic physical characteristics of a credit card and can be handled as a typical credit card. The SKC is either in an active state or an inactive state. In an active state the SKC can perform transactions in on-line mode, i.e. connected to a computer via a remote card reader. In an inactive state the user can operate the SKC in off-line mode, i.e. not connected to a computer (standalone mode).

The owner activates the SKC by entering his secret code via the keys on the card. It may be a numeric code he received from a financial institution, or any other institution that issues a numeric code for use with the card.

The entry of the code via the keyboard on the SKC activates the card. Once active, the card can be issued as a regular credit card for banking (ATM), ID, cable TV, E-Commerce, etc.

After a preprogrammed specific period of time (for example 45 seconds) the SKC deactivates itself and returns to an inactive sleep mode, and cannot be used for active transactions such as banking (ATM), ID, cable TV, E-Commerce, etc. Once the time period is set for the SKC to be active, it remains set until such time as the user chooses to change it.

Applications and uses for the SKC include the following simple operations: Electronic wallet operations; Electronic banking operations; credit card equivalent operations; ATM actions; Cable/TV transactions; ID card transactions; E-Commerce transactions via the internet; phone transactions with the use of a credit card (but providing a solution for the missing receipt (i.e. proof of purchase via proper use of the card)); opening and closing safety boxes, tracking time of activity, use and dates for entry and exit of the boxes, tracking a history of such activities; and security card operations for entering facilities, rooms, and institutions (such as schools, dorms, etc). The same SKC can be used for more than one of the applications listed above.

Complex operations with the SKC include generating a random transaction number that is associated with the SKC card and the secret code. For each remote or local transaction, the SKC generates a new random number. Hence, there is never a question if the transaction took place or not, because each transaction has its own unique transaction number.

The unique random transaction number appears on the display on the card. This number can be used in paperless transactions, such as a purchase over the phone or E-Commerce. The random transaction number becomes a digital signature of the buyer and ample proof that the user knew of and authorized the transaction. In particular, the owner has to activate the SKC via his SKC secret code, select the proper AN (application number) code to display the new transaction code and read the transaction code over the phone to the seller. Only the owner can do both.

### BRIEF DESCRIPTION OF THE DRAWINGS

Various aspects of non-limiting embodiments of the present invention will become more apparent by describing such embodiments below in conjunction with the attached drawings, in which:

FIG. 1 shows the construction and layout of the components of an illustrative embodiment of a Smart Key Card with a conventional magnetic strip;

FIG. 2 shows an illustrative embodiment of the logical design of the Smart Key Card of FIG. 1;

FIG. 3 shows the construction and layout of the components of an illustrative embodiment of a Smart Key Card with an international standard smart card chip;

FIG. 4 shows an illustrative embodiment of the logical design of the Smart Key Card of FIG. 3;

FIG. 5 shows an illustrative embodiment of the physical layout of the circuit components of a Smart Key Card hybrid chip;

FIG. 6 is a system logic flow chart, which describes system operations of an illustrative embodiment of the present invention; and

FIG. 7 is a flow chart showing a method of an illustrative embodiment of the present invention for generating a unique transaction number.

### DESCRIPTION OF THE ILLUSTRATIVE EMBODIMENTS OF THE INVENTION

The following description of the embodiments discloses specific configurations, features, and operations. However, the embodiments are merely examples of the present invention, and thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations, features, and operations of the present invention that would have been known to one skilled in the art are omitted for the sake of clarity and brevity.

The following is a description of the method, logic design, and associated circuitry for enabling the SKC to become active and communicate with the outside world. The logic design applies to both an SKC with a conventional magnetic strip and an SKC with an international standard smart card chip.

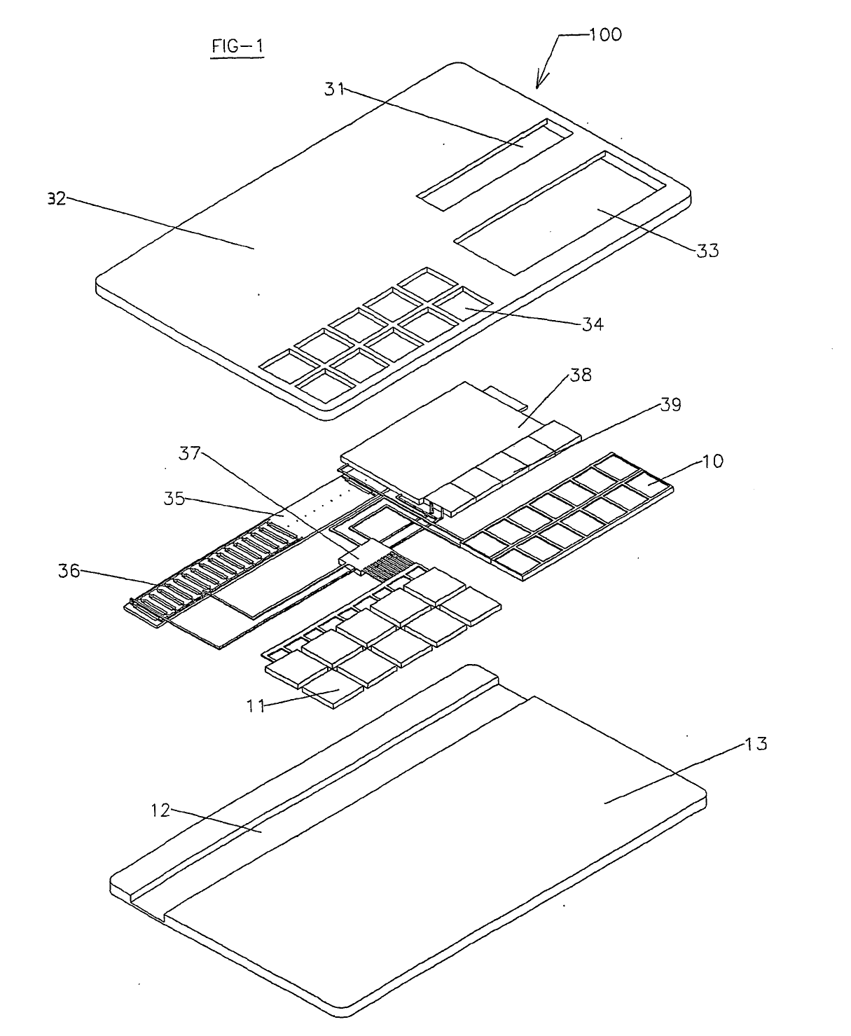

As shown in FIG. 1, the SKC 100 includes a plastic cover 32 with a photo cell window 31, display window 33, and keyboard window 34. Also included is a plastic base 13 with a magnetic strip placement portion 12, in which the magnetic strip 35 comprising magnetic strip components 36 is placed.

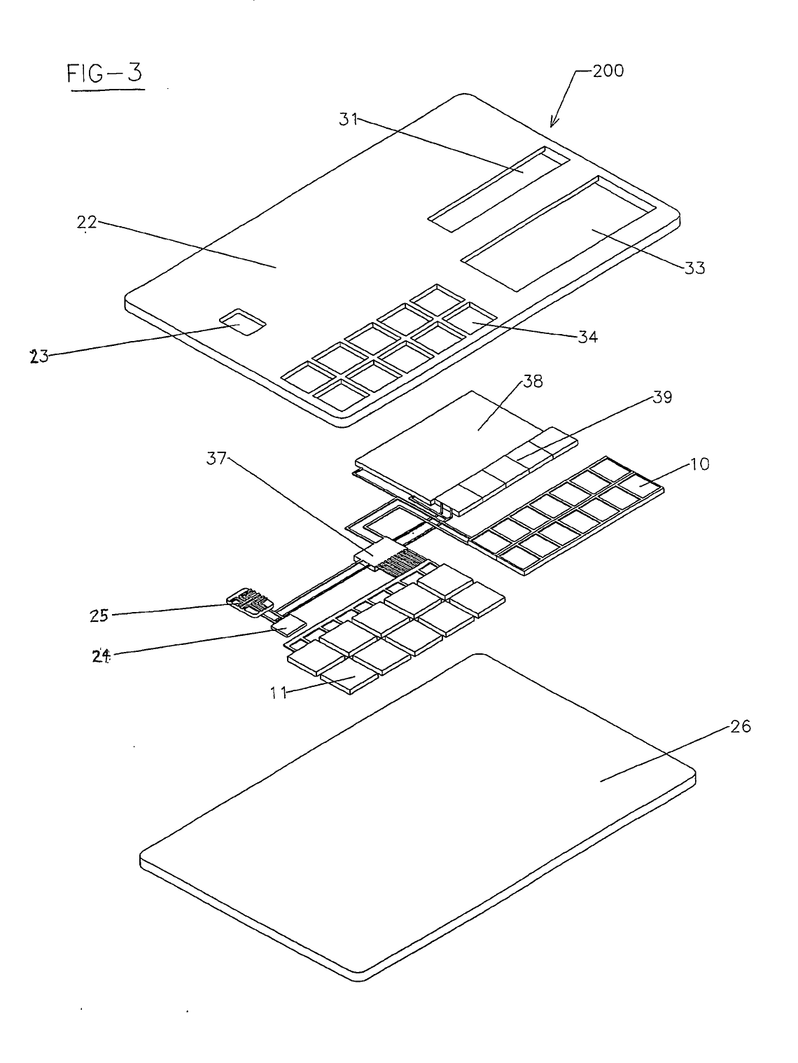

The SKC 200 shown in FIG. 3 includes a plastic cover 22 which is similar to the plastic cover 32 of SKC 100, except that the plastic cover 22 also has a window 23 for a commercially available standard smart card plug. The plastic base 26 of SKC 200 does not include a magnetic strip placement portion 12 like the SKC 100 of FIG. 1.

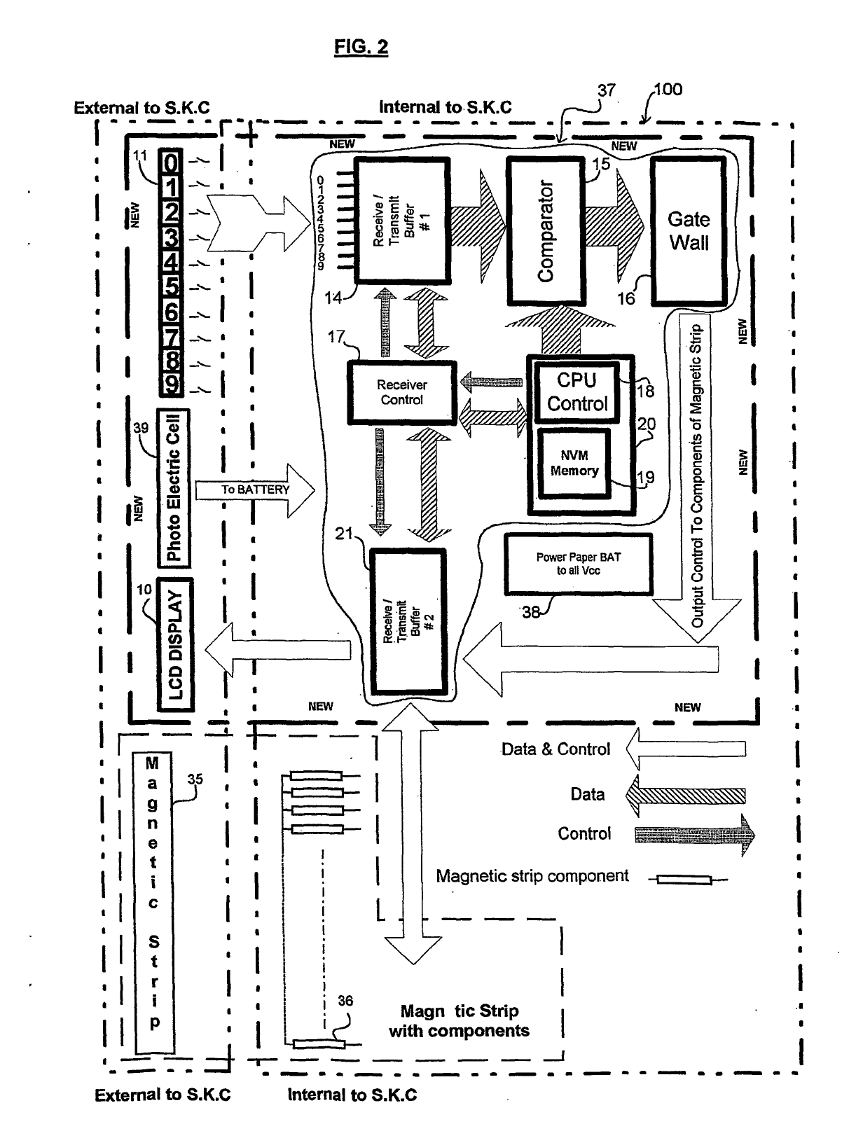

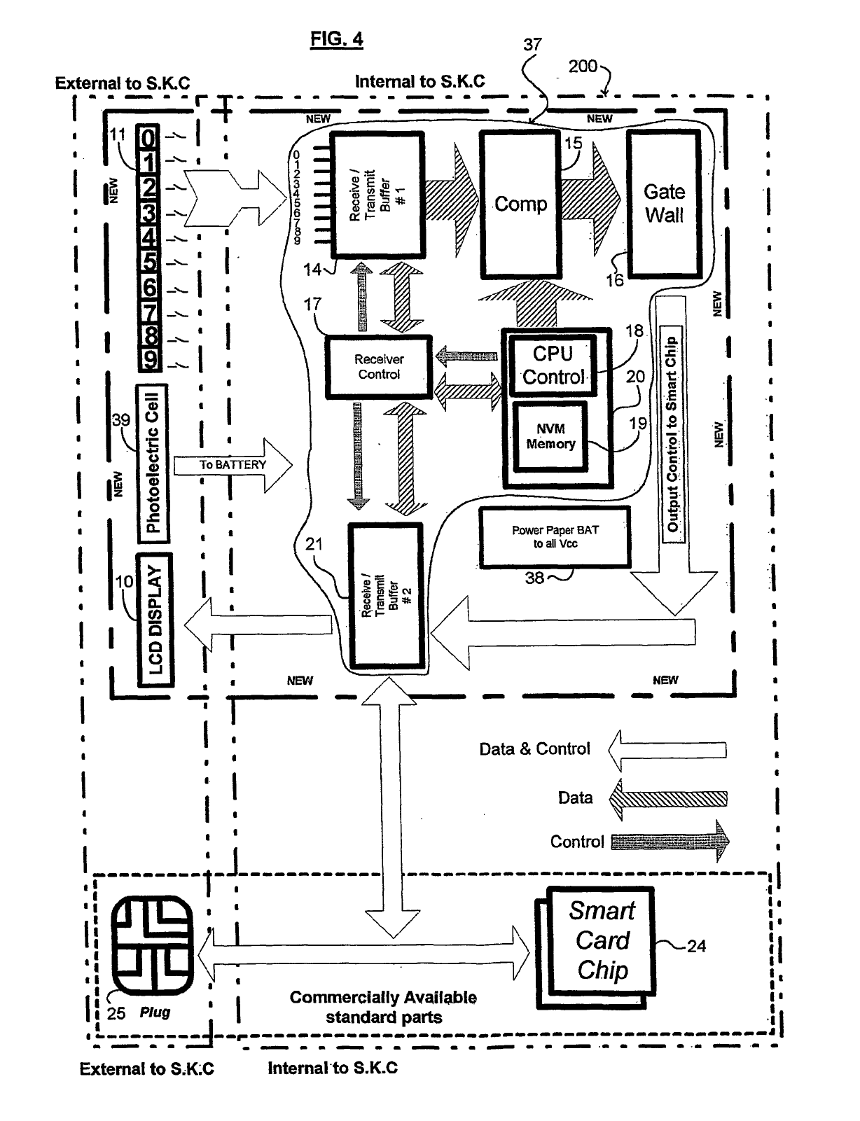

The owner of the card keys his secret code, for example 4 digits, via the keyboard 11 on the SKC 100, as shown in FIGS. 1 and 2. For the SKC 200 with a smart card chip 24 (see FIGS. 3 and 4), this action activates the SKC 200 and enables communications between the external plug 25 (communicates with programs external to the SKC) and the programs stored in the card. For the SKC 100 with the conventional magnetic strip 35, this action activates the magnetic strip 35 and enables communications between the magnetic strip 35 (that is in an input/output reader device) and the programs stored in the card.

The entry of the secret code activates the circuitry of the SKC. As shown in FIG. 2 and FIG. 4, the new code appears on inputs 0-9 in the Receive/Transmit Buffer#1 circuit 14.

The CPU/Non-Volatile Memory (NVM) 20 activates the applicable program that protects the SKC against theft, and the CPU/NVM 20 retrieves the true code from storage and loads it to the comparator 15. The CPU/NVM 20 enables a compare operation between the keyed information and the true code information in the comparator 15.

For the SKC 200 in FIG. 3, if the secret code entered by the user is the same as the true code, an authorization is issued to the Gate Wall circuit 16 that in turn enables the Smart Chip 24 to become active and communicate with the external world.

If the secret code entered by the user is not the same as the true code, an authorization is not issued to the Gate Wall circuit 16. Thus, communications between the magnetic strip. 36 or the Smart Card Chip 24 and the external world will not happen.

The time allowed for the Smart Card Chip 24 to remain active is prestored and can be reprogrammed in the CPU/NVM 20. If the time exceeds the preset boundaries of about 30-90 seconds, the CPU 18 issues a stop command to the Smart Card Chip 24 via the Receiver Control circuitry 17 and communication with the external world is disabled.

For the SKC 100 in FIG. 2, if the secret code entered by the user is the same as the true code, an authorization is issued to the Gate Wall circuit 16, that in turn enables the magnetic strip to become activated and communicate between the external world and the SKC 100.

If the secret code entered by the user is not the same as the true code, an authorization is not issued to the Gate Wall circuit 16. Thus, communications between the magnetic strip and the external world and the SKC 100 will not happen.

The time allowed for the magnetic strip to remain active is stored and can be reprogrammed in the CPU/NVM 20. If the time exceeds the preset boundaries of about 30-90 seconds, the CPU 18 issues a stop command to the magnetic strip via the Receiver Control circuitry 17 and communication between the external world and the SKC 100 is disabled.

The Card's power will enable the card to operate for at least 15,000-20,000 electronic operations.

The following describes an illustrative embodiment of the elements in the SKC Basic Logical Design of FIGS. 2 and 4.

The display 10 is preferably an LCD type 7sig that enables the owner to receive information from the SKC. This information completes different SKC operations such as credit card number, activities, time, etc.

The LCD display has two display lines. Each line has a minimum of 7 digits. Examples of the types of display that can be used include the following: RS SN 214-3395 or RS SN 214-3402 or equivalent.

The photoelectric cell 39 converts light energy to electric-energy between 3-5 Vdc. The cell 39 is connected to an internal battery 38 of the power paper battery type. The parallel connection of the cell 39 enables charging the battery 38 and supplying an operational voltage Vcc in case the battery 38 becomes drained.

In one implementation, at least a five cell type battery that generates 3.3 or 5 Vdc is used, such as RS-CP18, Ed Sci#B36,083 or Ed Sci#B37,336 or equivalent.

The keypad 11 has keys that supply a binary code to the Receive/Transmit Buffer#1 circuit 14. The owner uses them to enable the SKC and enter information to the SKC circuitry.

In one implementation, a metal type, fully enclosed, unlit keypad, such as RS IP67 or type FH 24-60 Flex heat or equivalent is used.

The Receive/Transmit Buffer#1 circuit 14 is located between the comparator 15 and the keyboard 11. The Receive/Transmit Buffer#1 circuit 14 identifies the key pressed according to a matrix, wakes up the circuit after the first key is pressed, and transfers the information received from the keys (e.g. digits in binary format) to the comparator 15.

Non-limiting examples of the Receive/Transmit Buffer#1 circuit 14 include the following: Types LM139/LM239; MAX 3170 evaluation kit; Altera a6402 or equivalent.

The Receiver Control circuitry 17 commands and controls the two-way transfer of information from (to) the Receive/Transmit Buffer#1 circuit 14 and the Receive/Transmit Buffer#2 circuit 21 to (from) the CPU/NVM 20.

The function of the Second Receive/Transmit Buffer circuit 21 is to buffer and transmit information under the command and control of the CPU 18 within the CPU/NVM 20. For the SKC 200, the circuit 21 buffers and transfers information from the external plug 25 to the CPU 18 or enables connectivity between the external plug 25 and Smart Card Chip 24. For the SKC 100, the circuit 21 buffers and transfers information from the magnetic strip to the CPU 18.

Examples of the Receive/Transmit Buffer#2 circuit 21 include: Types LM139/LM239; MAX 3170 evaluation kit; Altera a6402 or equivalent.

The Comparator 15 performs a binary compare operation between two sources. The first source is from the external world via the buffer#1 circuit 14 and the second is the true code information that is stored in a table in the NVM 19 and that is retrieved by the CPU 18.

The result of the compare operation either activates the SKC (i.e. when the information from the buffer#1 circuit 14 equals the true code information) or keeps the SKC disabled (i.e. when the information from the buffer#1 circuit 14 does not equal the true code information).

The comparator 15 performs compare operations between two binary serial or parallel lists Non-limiting examples of the Comparator 15 include: Type AD790JN (AD); KA2903 (SAM) or equivalent.

The Gate Wall circuit 16 is a security circuit that operates at cipher level SSL (Secure Sockets Layer). It also performs odd parity checks on binary information.

A non-limiting example of the type of circuit used for the Gate Wall circuit 16 is the ALTERA P-Generator Flex 8000 or equivalent.

The CPU Control 18 is a processor such as the Intel 486 or 386 or equivalent. However, other processors can clearly be used.

A non-limiting example of the NVM Memory 19 is the Altera MAX 3000 or equivalent.

Non-limiting examples of the Power Paper BAT battery include: NTK model PDX 203455 or PDX 352252 or equivalent.

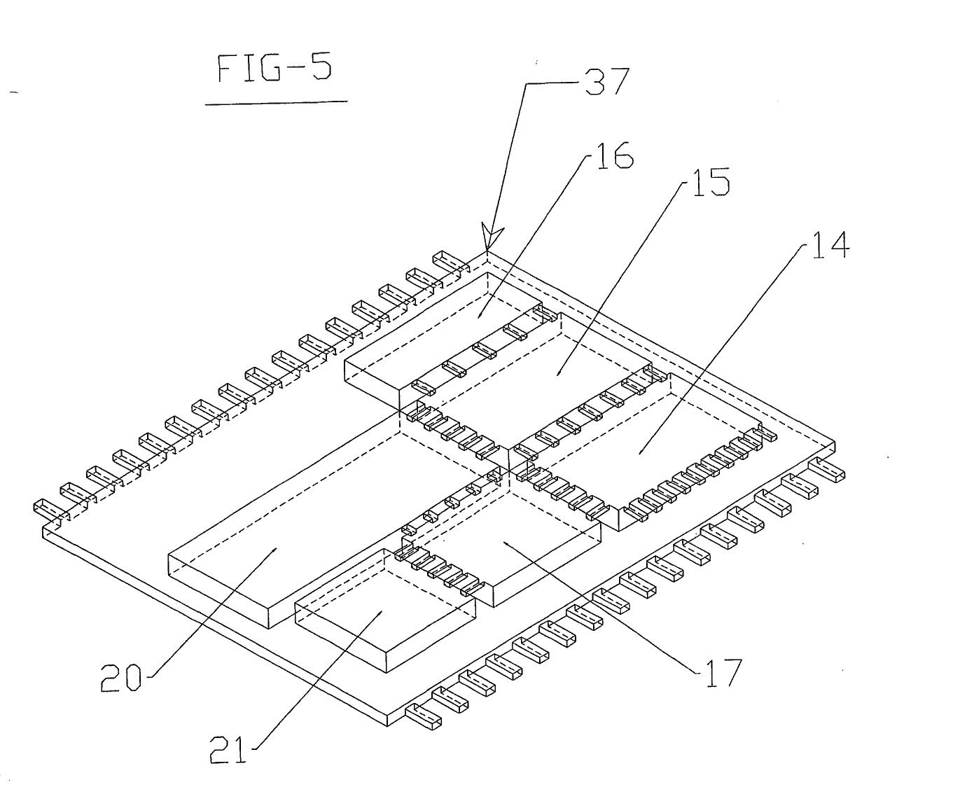

The hybrid chip 37, as shown in FIG. 5, is a specially designed ASIC chip that contains the logic of the Gate Wall circuit 16, Comparator 15, Receive/Transmit Buffer#1 circuit 14 and Receive/Transmit Buffer#2 circuit 21, Receiver Control circuitry 17, and CPU/NVM 20.

For the SKC 200, the Smart Chip Card communicates with input/output devices (ATM, ID readers, etc.) according to commercially specified protocols. For the SKC 100, the magnetic strip communicates with input/output devices (ATM, ID) readers, etc.) via the magnetic strip according to commercially specified protocols.

Non-limiting examples of the Smart Chip Card include: Gemplus or Motorola (SIT) or Philips Semiconductors 16 bit smart XA application or equivalent.

The Chip Plug 25 connects the SKC 200 to an input/output device such as ATM or CABLE/TV etc. according to industry standards and are commercially available.

The applications for the SKC 100 or 200 are program driven. The programs are prestored in the NVM 19. The owner can select the program of his choice to exercise one of the following applications: Program for banking applications, Program for ID information management, Program based on ECommerce transactions, and General purpose application program. Furthermore, upon reading the specification, one skilled in the art will understand how to implement many other programs.

Program for banking applications include: An ATM Card, Electronic Wallet, and Credit Card Function. The program enables the owner to connect with the external world of banking and enables security for the information it stores. The program is stored in NVM 19 under control of the CPU 18. The CPU 18 commands and operates all components and circuitry in the SKC 100 or 200.

The Program for ID information management may replace conventional ID cards. The card is based on the specific personal needs of the owner and the requirements of the authorities that ask for the ID. The program enables the owner communications with the external world to receive and transmit information. The program provides a high level of security. The program is stored in NVM 19 and operates under the command and control of the CPU 18 and other components and circuitry of the SKC 100 or 200. The program manages communications with CABLE/TV. The program ensures a high level of security for the owner/user and manages communications and transactions in E-Commerce.

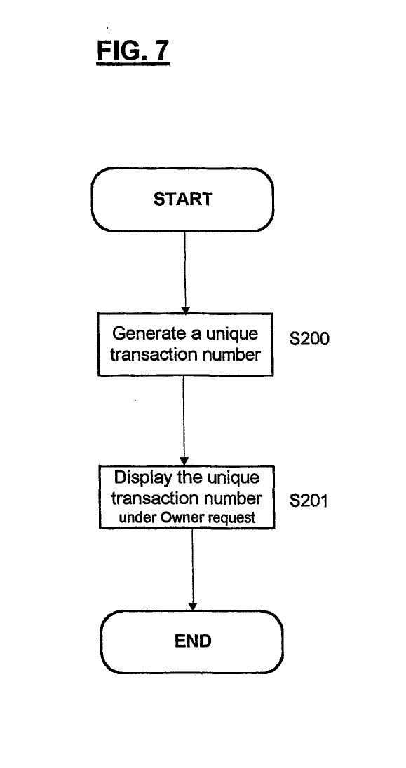

The Program based on E-Commerce transactions uses the principle of issuing a “new” card number with each transaction. Each transaction has a new SKC “card number” (the SKC number+the random transaction number). The transaction number appears on the SKC display 10 and enables the owner to copy the number or provide it to the remote seller thus creating proof of purchase in lieu of the current paperless transaction. A method for generating a new SKC card number for each transaction, as discussed below, is shown in FIG. 7.

The general-purpose application program is any other application that can be developed and stored in the NVM 19 under the command and control of the CPU 18. Examples of these applications include: Healthcare (HMO) ID Cards; Driver License ID Cards; Security ID Key Cards for Hotels, Lockers, Car Doors, and Safe Deposit Boxes; Employee ID Cards; and Check IN/OUT Cards.

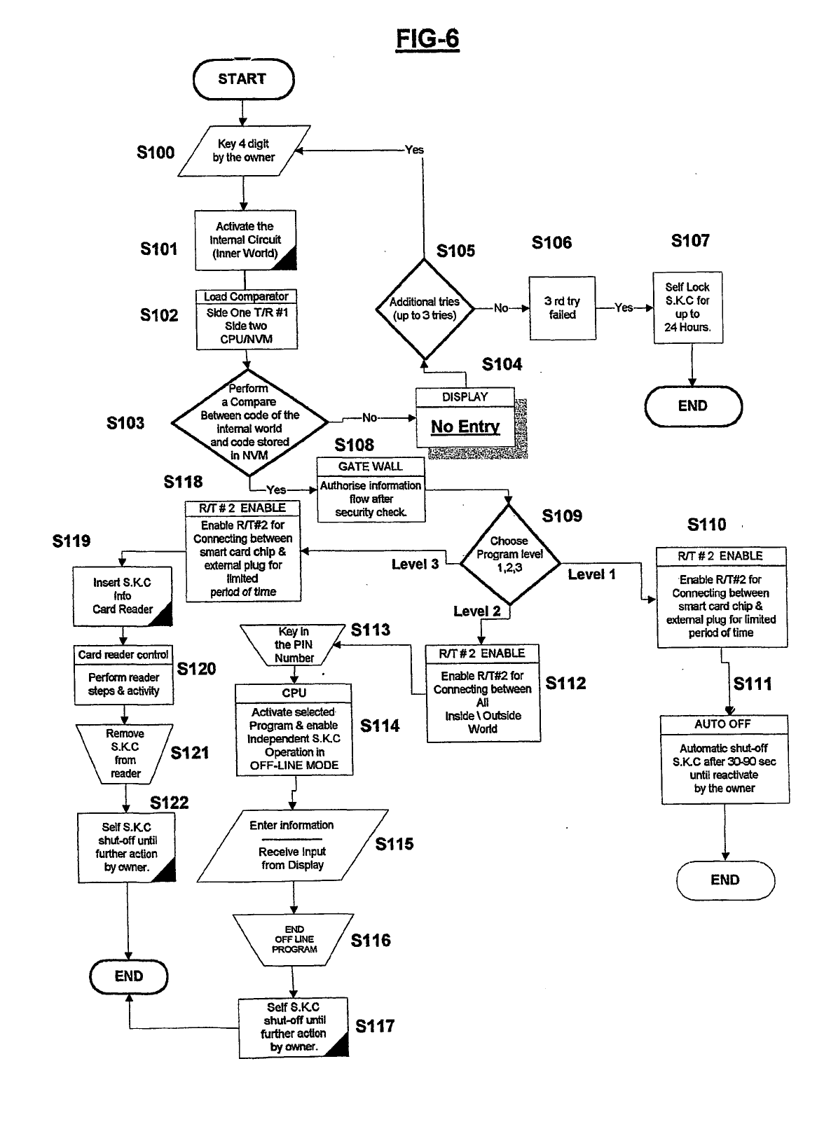

The method of operating the SKC 100 or 200 to load and store information will now be described with reference to FIGS. 6 and 7.

In operation S100, the user enters a 4 digit secret code. In operation S101, the SKC 100 or 200 is activated so that the remaining operations can be performed. The comparator 15 is loaded with the secret code entered by the user and a true code stored in the NVM 19 in operation S102. These two codes are compared in operation S103. For instance, the CPU 18 loads the comparator 15 with the stored true code, and the comparator 15 performs a compare operation against the secret code entered via the keys of the keyboard 11 on the SKC 100 or 200.

If the two codes are not equal, words such as “No Entry” are displayed in operation S104. Then, the SKC 100 or 200 returns to inactive mode and the user can try to enter the correct secret code up to three times in operation S105. After the secret code is incorrectly entered three times, as determined in operation S106, the SKC 100 or 200 performs a self-locking operation for up to twenty-four hours in operation S107.

If the comparator 15 determines that the true code was entered by the user, in operation S108, the Gate Wall circuit 16 authorizes information flow to begin between the SKC 100 or 200 and the external world.

In operation S109, the user chooses one of the program levels via the display 10 and the keyboard 11, which determines which type of operation the SKC 100 or 200 will perform. The CPU 18 loads the selected program to the NVM 19.

If program level one is selected, then in operation S110 the Receive/Transmit Buffer#2 circuit 21 is enabled for connecting the smart card chip 24 to the external plug 25 for a predetermined time period. After the predetermined time period of 30-90 seconds expires, the SKC 200 is shut off in operation S111. Thus, the SKC 200 disables the connection to the external world and protects the SKC 200 from tampering or misuse by unauthorized users. In the SKC 100, an analogous operation would be performed with respect to the magnetic strip.

If program level two is selected, then in operation S112 the Receive/Transmit Buffer#2 circuit 21 is enabled for connecting the SKC 100 or 200 to the outside world. In operation S113, the user enters an AN (application number). In operation S114, a user selected program is activated and independent operation of the SKC 100 or 200 in off-line mode is enabled. The information is entered by the user via the keyboard 11 and displayed on the display 10 in operation S115 to allow the user to enter, change, and/or delete information. The updated information is stored in the NVM 19. After the off-line program ends in operation S116, the SKC 100 or 200 shuts itself off in operation S117.

When the user selects program level three in operation S109, the Receive/Transmit Buffer#2 circuit 21 is enabled in operation S118 for connecting between the smart card chip 24 and the external plug 25 for a predetermined time period. In operation S119, the SKC 200 is inserted into an input/output device such as an ATM, Credit Card Reader, ID reader, CABLE/TV, etc.

In operation S120, the operation is continued as per the instruction of the input/output device to which the SKC 200 is connected. The SKC 200 will disable itself in operation S122, after the operation is completed and the SKC 200 is removed from the input/output device in operation S121. In the SKC 100, a similar operation is performed with respect to the magnetic strip.

FIG. 7 shows a method for generating a unique transaction number for each transaction of the SKC 100 or 200. In every active transaction such as banking or E-Commerce, the card (circuit) generates a new 16-digit number.

This number is generated in operation S200 via an algorithm in the operating program and is stored in the NVM 19 in a table that is maintained by the CPU 18. The generated new number is displayed in operation S201 on the SKC display as a unique coded number such that the owner can read it over the phone to a seller, or key it into a computer to execute an E-Commerce transaction. This unique operation provides a different SKC number for each transaction and acts as proof for paperless transactions.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. An electronic authorization/credit card, comprising:
a keypad for entering data;
a read/write magnetic strip which stores confidential information;
a battery; and
a smart key card hybrid chip,
wherein the smart key card hybrid chip is operative to activate the electronic authorization/credit card for a predetermined time period.

2. The electronic authorization/credit card as claimed in claim 1, further comprising a display which displays user information.

3. The electronic authorization/credit card as claimed in claim 1, further comprising a photo electric cell.

4. The electronic authorization/credit card as claimed in claim 1, wherein the smart key card hybrid chip comprises:
a CPU for controlling operation of the smart key card hybrid chip;
a non-volatile memory for storing user information, data and programs;
a first receive/transmit buffer for receiving and transmitting keypad data from the keypad;
a second receive/transmit buffer which receives and transmits data from the magnetic strip;
a receiver control which controls transfer of information from the first and second receive/transmit buffers to the CPU;
a comparator for comparing a code received from the first receive/transmit buffer to a true code stored in the non-volatile memory; and
a gate wall circuit which enables external communication.

5. The electronic authorization/credit card as claimed in claim 4, wherein the non-volatile memory stores a unique transaction number for each transaction of the electronic authorization/credit card.

6. An electronic authorization/credit card, comprising:
a keypad for entering data;
a smart card chip which stores confidential information;
a battery; and
a smart key card hybrid chip,
wherein the smart key card hybrid chip is operative to temporarily activate the electronic authorization/credit card for a predetermined time period.

7. The electronic authorization/credit card as claimed in claim 6, further comprising a display which displays user information by authorized user's request.

8. The electronic authorization/credit card as claimed in claim 6, further comprising a photo electric cell.

9. The electronic authorization/credit card as claimed in claim 6, wherein the smart key card hybrid chip comprises:
a CPU for controlling operation of the smart key card hybrid chip;
a non-volatile memory for storing user information;
a first receive/transmit buffer for receiving and transmitting keypad data from the keypad;
a second receive/transmit buffer which receives and transmits data from the magnetic strip;
a receiver control which controls transfer of information from the first and second receive/transmit buffers to the CPU;
a comparator for comparing a code received from the first receive/transmit buffer to a true code stored in the non-volatile memory; and
a gate wall circuit which enables external communication.

10. The electronic authorization/credit card as claimed in claim 9, wherein the non-volatile memory stores a unique transaction number for each transaction of the electronic authorization/credit card.

11. A method of operating an electronic authorization/credit card, comprising:
entering a code through a keypad on the electronic authorization/credit card;
comparing the entered code to a code stored in a non-volatile memory of the electronic authorization/credit card; and
authorizing information flow between the electronic authorization/credit card and the outside world, when the entered code and the stored code are the same.

12. The method of operating the electronic authorization/credit card as claimed in claim 11, further comprising choosing a program level.

13. The method of operating the electronic authorization/credit card as claimed in claim 12, wherein, when a first program level is selected, the method further comprises:
enabling a receive/transmit buffer for connecting between a smart card chip and an external plug on the electronic authorization/credit card for a predetermined time period; and
shutting off communication between the electronic authorization/credit card and the outside world, automatically, after the predetermined time period expires.

14. The method of operating the electronic authorization/credit card as claimed in claim 12, wherein, when a second program level is selected, the method further comprises:
enabling a receive/transmit buffer for connecting the electronic authorization/credit card to the outside world;
entering an application number through the keypad;
selecting a program for operation in off-line mode through the keypad and a display on the electronic authorization/credit card; and
modifying information stored in the non-volatile memory.

15. The method of operating the electronic authorization/credit card as claimed in claim 14, wherein the method further comprises:
ending the off-line program; and
shutting off the electronic authorization/credit card, automatically, after the ending of the off-line program.

16. The method of operating the electronic authorization/credit card as claimed in claim 12, wherein, when a third program level is selected, the method further comprises:
enabling a receive/transmit buffer for connecting between a smart card chip and an external plug on the electronic authorization/credit card for a predetermined time period;
inserting the electronic authorization/credit card into an input/output device; and
operating the electronic authorization/credit card based on instructions of the input/output device;

17. The method of operating the electronic authorization/credit card as claimed in claim 16, wherein the method further comprises:
removing the electronic authorization/credit card from the input/output device; and
shutting off the electronic authorization/credit card, automatically, after the electronic authorization/credit card is removed from the input/output device.

18. A method of generating a unique transaction number for each transaction of an electronic authorization/credit card, comprising:
generating the unique transaction number from a non-volatile memory in the electronic authorization/credit card; and
displaying the unique transaction number on a display located on the electronic authorization/credit card.

19. The method of generating a unique transaction number as claimed in claim 18, wherein the unique transaction number is a 16-digit number.
